(19) United States
(12) Patent Application Publication
(10) Pub. No.: US 2023/0047726 A1
(43) Pub. Date: Feb. 16, 2023

(54) LOW COMPLEXITY PHYSICAL DOWNLINK CONTROL CHANNEL

(71) Applicant: QUALCOMM Incorporated, San Diego, CA (US)

(72) Inventors: Huilin XU, Temecula, CA (US); Jing LEI, San Diego, CA (US); Chao WEI, Beijing (CN); Peter Pui Lok ANG, San Diego, CA (US); Wanshi CHEN, San Diego, CA (US); Hwan Joon KWON, San Diego, CA (US); Peter GAAL, San Diego, CA (US)

(21) Appl. No.: 17/760,265

(22) PCT Filed: Mar. 20, 2020
(86) PCT No.: PCT/CN2020/080334

§ 371 Date: Aug. 5, 2022

(51) Int. Cl. H04W 24/08; H04W 72/04; H04L 1/00; H04L 27/26

(52) U.S. Cl. CPC H04W 24/08; H04W 72/042; H04W 72/044; H04L 1/0038; H04L 27/26025

(57) ABSTRACT

Certain aspects of the present disclosure provide techniques for low complexity physical downlink channel. A method that may be performed by a user equipment (UE) includes determining one or more policies for monitoring one or more physical downlink control channels (PDCCHs) within one or more bandwidth parts (BWPs) for a first type of UE, wherein the one or more policies for the first type of UE are different from a set of policies for a second type of UE; and monitoring for signals from a network entity via the one or more PDCCHs according to the determined policies.

### BACKGROUND

### Field of the Disclosure

Aspects of the present disclosure relate to wireless communications, and more particularly, to techniques for low complexity physical downlink control channel monitoring policies, which may be desirable for reduced capability or low complexity user equipment.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include PDCCH monitoring policies desirable for reduced complexity UEs or low complexity UEs.

Certain aspects of the subject matter described in this disclosure can be implemented in a method for wireless communication by a user equipment (UE). The method generally includes determining one or more policies for monitoring one or more physical downlink control channels (PDCCHs) within one or more bandwidth parts (BWPs) for a first type of UE, wherein the one or more policies for the first type of UE are different from a set of policies for a second type of UE; and monitoring for signals from a network entity via the one or more PDCCHs according to the determined policies.

Certain aspects of the subject matter described in this disclosure can be implemented in a method for wireless communication by a network entity. The method generally includes determining one or more policies for transmitting signals via one or more physical downlink control channels (PDCCHs) within one or more bandwidth parts (BWPs) for a first type of user equipment (UE), wherein the one or more policies for the first type of UE are different from a set of policies for a second type of UE; and transmitting the signals to the UE via the one or more PDCCHs according to the determined policies.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is an example of control regions for certain wireless communication systems (e.g., NR), in accordance with certain aspects of the present disclosure.

FIG. 5 illustrates a signaling flow for low complexity physical downlink control channel (PDCCH) monitoring, in accordance with certain aspects of the present disclosure.

FIG. 6 illustrates an example of partially overlapping PDCCH monitoring occasions in a slot, in accordance with certain aspects of the present disclosure.

FIG. 7A depicts a table of example blind decode (BD) limits (i.e., maximums) in a slot for certain subcarrier spacings (SCSs), in accordance with certain aspects of the present disclosure.

FIG. 7B depicts a table of another example of BD limits in a slot for certain SCSs, in accordance with certain aspects of the present disclosure.

FIG. 8 is a flow diagram illustrating example operations for wireless communication by a UE, in accordance with certain aspects of the present disclosure.

FIG. 9 is a flow diagram illustrating example operations for wireless communication by a network entity (e.g., a BS), in accordance with certain aspects of the present disclosure.

FIG. 10 illustrates a communications device (e.g., a UE or BS) that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for low complexity physical downlink control channel (PDCCH) monitoring. In certain cases, the various policies may include fewer blind decodes to perform, fewer control channel elements (CCEs) to monitor, fewer control resource sets (CORESETs) to monitor, fewer search space sets to monitor, a higher floor for aggregation levels (ALs), and/or low complexity quasi colocation (QCL) configurations. The various policies for PDCCH monitoring described herein may enable a UE to reduce its form factor, processing complexity, transceiver complexity, and/or power consumption.

The following description provides examples of PDCCH monitoring in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

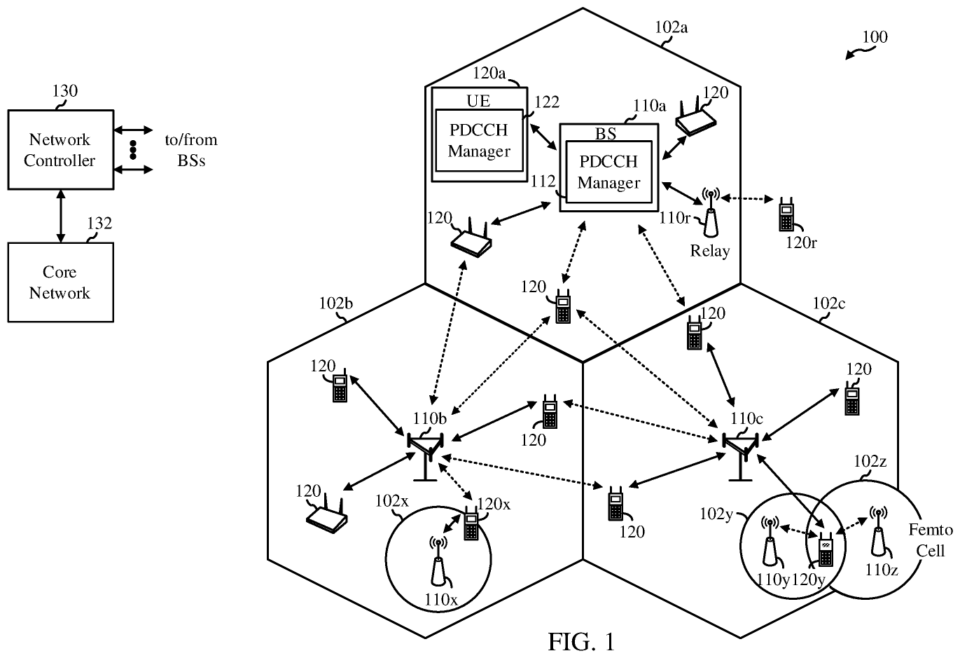

FIG. 1 illustrates an example wireless communication network 100 in which aspects of the present disclosure may be performed. For example, the wireless communication network 100 may be an NR system (e.g., a 5G NR network).

As shown in FIG. 1, the BS 110a includes a PDCCH manager 112 that applies the various policies for PDCCH monitoring for reduced capability UEs, in accordance with aspects of the present disclosure. The UE 120a, as a reduced capability UE, includes a PDCCH manager 122 that applies the various policies for monitoring the PDCCH, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

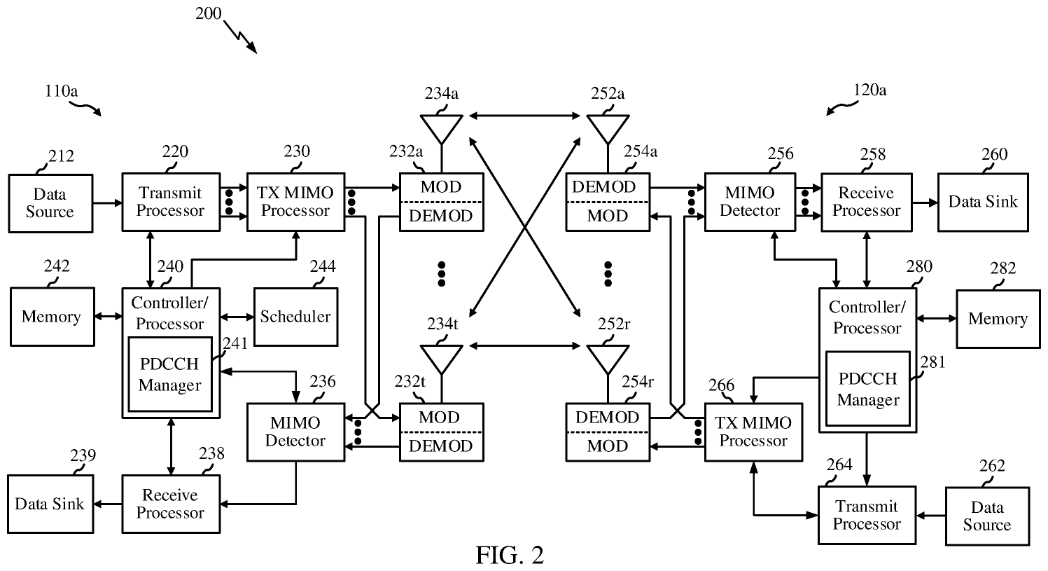

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a PDCCH manager 241 that applies the various policies for PDCCH monitoring for a reduced capability UE, according to aspects described herein. As shown in FIG. 2, the controller/processor 280 of the UE 120a has a PDCCH manager 281 that applies the various policies for PDCCH monitoring, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

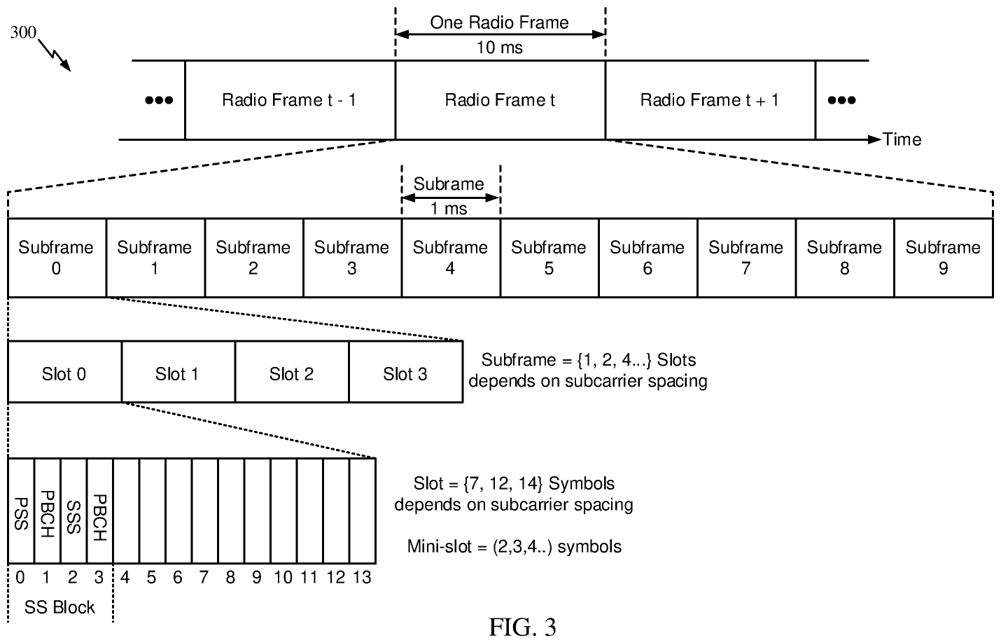

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

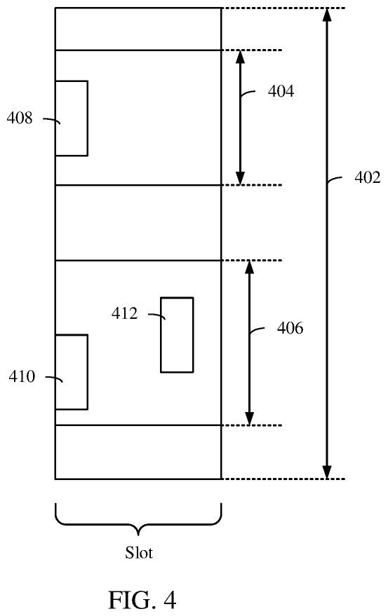

FIG. 4 is a diagram showing an example of control resource sets (CORESETs) within a carrier bandwidth across a slot in NR. As shown, a carrier bandwidth (CBW) 402 may have multiple bandwidth parts (BWPs) 404, 406 at various subcarrier spacings (SCS). In this example, the BWP 404 is configured with a single CORESET 408, and the BWP 406 is configured with CORESETs 410, 412. In aspects, a BWP may be configured with multiple CORESETs. Each of the CORESETs 408, 410, 412 include a set of physical resources within a specific area in downlink resource grid and are used, for example, to carry downlink control information (DCI). In a CORESET, the set of resource blocks (RBs) and the number of consecutive OFDM symbols in which the CORESET is located are configurable with CORESET configuration and time domain location of the OFDM symbols is configurable with corresponding PDCCH search space (SS) set(s). A search space set may be configured with a type of SS set (e.g., common search space (CSS) set or a UE-specific search space (USS) set), a DCI format to be monitored, a monitoring occasion, and the number of PDCCH candidates for each aggregation level (AL) in the SS set. In other words, a search space set is a set of one or more search spaces, where each search space corresponds to an AL (e.g., the number of control channel elements for a PDCCH candidate). The configuration flexibilities of control regions (i.e., CORESETs and associated search space sets) including time, frequency, numerologies, and operating points enable NR to address a wide range of use cases for control signaling (e.g., various desired latencies and/or various channel conditions). In certain wireless communication systems (e.g., LTE), the PDCCH is allocated across an entire system bandwidth, whereas an NR PDCCH is transmitted in the CORESET(s) of an active BWP, for example, the CORESETs 410, 412 of BWP 406.

### Example Low Complexity PDCCH

Certain wireless communication systems (e.g., 5G NR systems) provide services with relatively high data rates and low latencies (such as eMBB and/or URLLC), which may result in a large UE form factor, high UE hardware costs, high UE complexity (e.g., memory, processor, and/or transceiver circuits), and/or high UE power consumption. 5G NR systems also provide very flexible PDCCH monitoring configurations, e.g., fully configurable time resources, frequency resources, and periodicity pattern for PDCCH monitoring, as described herein with respect to FIG. 4. Under the flexible PDCCH monitoring regime, 5G NR systems provide a relatively large number of potential PDCCH decodes with multiple CORESETs and SS sets and flexible quasi colocation (QCL) configuration (in the form of transmission configuration indicator (TCI) states) for the tracking of channel variations. As such, the PDCCH monitoring configuration of a UE plays a role in determining the complexity of a UE, such as the form factor, hardware costs, circuit complexity, and/or power consumption.

5G NR systems may also provide services for reduced capability UEs. In certain cases, the reduced capability UE may have reduced processing capabilities (e.g., reduced memory or processing times) and/or transceivers with lower complexity (e.g., fewer transmit and/or receive paths). As a result, the reduced capability UE may have a smaller form factor, lower hardware costs, lower circuit complexity, and/or lower power consumption than UEs supporting higher data rates and/or lower latency. As an example, a reduced capability UE may be a wearable wireless communication device (such as a smart watch or activity tracker), a video surveillance device, or an industrial Internet-of-Things (IIoT) device.

Aspects of the present disclosure provide various policies for low complexity PDCCH monitoring for reduced capability UEs. In certain cases, the various policies may include fewer blind decodes to perform, fewer control channel elements (CCEs) to process, fewer CORESETs to monitor, fewer search space sets to monitor, a higher floor for aggregation levels (ALs), and/or low complexity QCL configurations (i.e., active TCI states). The various policies described herein may enable a UE to reduce its form factor, processing complexity, transceiver complexity, and/or power consumption. In other words, the various policies described herein may provide desirable power consumption and processing timelines for reduced capability UEs.

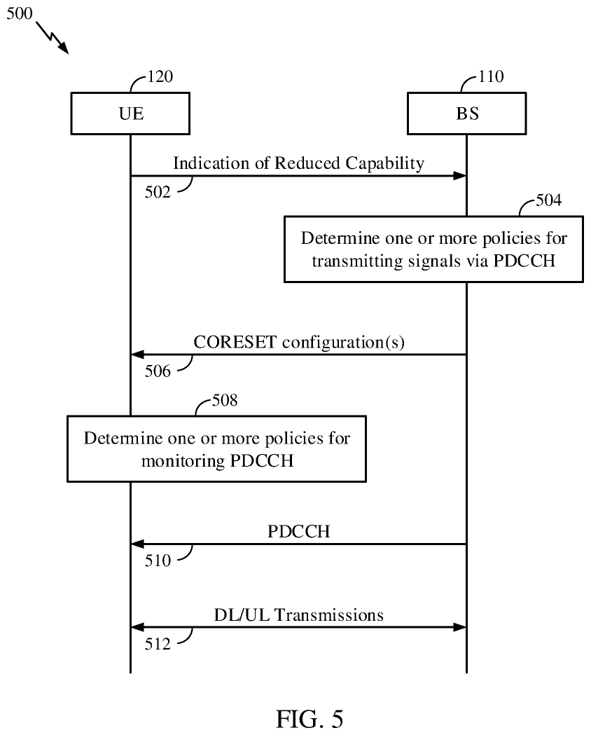

FIG. 5 illustrates a signaling flow for low complexity PDCCH monitoring, in accordance with certain aspects of the present disclosure. As shown, at 502, the UE 120 may signal, to the BS 110, an indication that the UE is a reduced capability UE. In certain cases, the indication of the reduced capability may be transmitted via radio resource control (RRC) signaling (e.g., RRC capability information) or RACH signaling (e.g., a specific preamble sequence associated with reduced capability UEs). At 504, the BS 110 may determine one or more policies for configuring the UE 120 for PDCCH monitoring via CORESETs and transmitting and receiving signals on the BWP as further described herein. In aspects, the policies for the reduced capability UE are different from a set of policies for another type of UE, such as a UE that supports eMBB or URLLC. In aspects, the policies for the reduced capability UE may be pre-programmed at the BS 110. In certain cases, at least some of the policies may be included in the indication at 502. That is, the indication at 502 may also include an indication of the PDCCH monitoring capabilities of the UE 120. At 506, the BS 110 may transmit, to the UE 120, one or more CORESET configurations, in accordance with the policies determined at 504. For example, the BS 110 may configure the UE 120 with a single CORESET in a BWP, where the CORESET has a single CSS set and a single USS set. At 508, the UE 120 may determine the policies for monitoring the PDCCH within the BWP as further described herein. At 510, the UE 120 may monitor the PDCCH transmitted from the BS 110 in accordance with the determined policies. For example, the policies may provide that the UE 120 has a lower ceiling for performing BDs for a certain SCS within a certain time-domain resource unit (e.g., a slot) than under the set of policies for another type of UE, such as the UE that supports eMBB or URLLC. The UE 120 may perform BDs within the time-domain resource unit at the SCS in accordance with the lower maximum. In certain cases, the UE 120 may receive downlink or uplink scheduling via the PDCCH at 510, and at 512, the UE 120 may transmit uplink signals or receive downlink signals according to the scheduling.

In certain aspects, the PDCCH monitoring policies for a reduced capability UE may include various CORESET policies. In 5G NR systems, a UE supports up to three CORESETs in a BWP and up to ten SS sets in a BWP. For a reduced capability UE, the CORESET policies may provide that the UE supports at most a single CORESET per BWP, a single CSS set per BWP, and a single USS set per BWP.

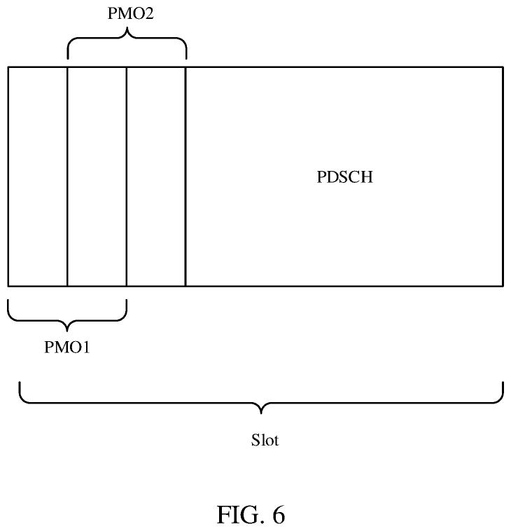

In aspects, the CORESET policies may provide how certain SS sets may overlap in the time domain. For example, in 5G NR systems, a UE does not expect to be configured with partially overlapping SS set occasions (SS set occasion is also called PDCCH monitoring occasion (PMO), which is analogous to control region for LTE) in the time-domain from the same or different SS sets associated with the same CORESET. The rationale is that there is no spatial multiplexing gain or interference randomization effect for SS set occasions in the same CORESET. FIG. 6 illustrates an example of partially overlapping PMOs in a slot, in accordance with certain aspects of the present disclosure. As shown, the PMO1 partially overlaps with the PMO2 across an OFDM symbol, which may be allowed for different CORESETs, but not the same CORESET, in certain cases.

For a reduced capability UE, the CORESET policies may apply additional or alternative rules for how certain SS sets may overlap in the time domain. In certain cases, SS set occasions from the same or different SS sets associated with the same CORESET may not be allowed to fully overlap in the time-domain. In certain cases, there may be no overlap (partial or full) in the time-domain between SS set occasions for different CORESETs. In certain cases, full overlap in the time-domain is allowed between SS set occasions from different CORESETs only if these CORESETs have the same frequency domain RB allocation and time domain OFDM symbol duration. These CORESET policies may be applied in various combinations. In other words, the CORESET policies may not be mutually exclusive of each other.

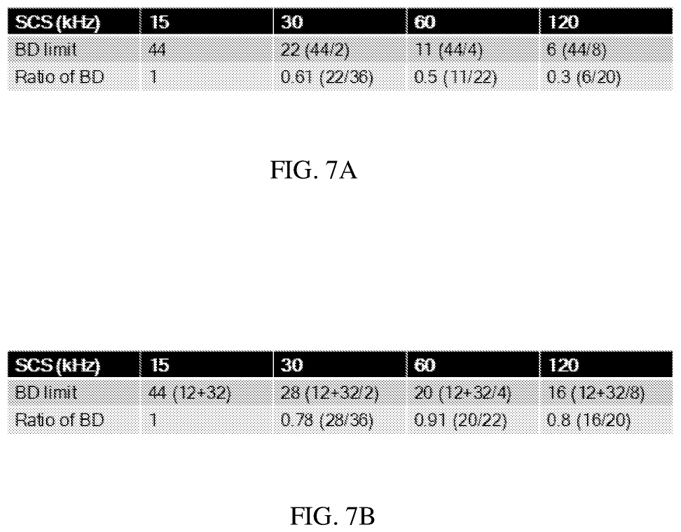

In certain aspects, the PDCCH monitoring policies for a reduced capability UE may include various BD policies that set a maximum number of BDs that the UE expects to perform in a time-domain resource unit (e.g., a slot) per SCS. In aspects, the BD policies may set a lower maximum number of BDs for a certain SCS than under the set of policies for the second type of UE. In certain cases, a particular SCS may provide a base or root maximum number of BDs, and the other SCSs may reduce the base maximum by a certain factor (such as 2^{x}) depending on the SCS. As an example, FIG. 7A depicts a table of BD limits (i.e., maximums) in a slot for certain SCSs, in accordance with certain aspects of the present disclosure. In this example, the BD limit for 15 kHz provides the base BD limit, the BD limit for 30 kHz SCS reduces the base by half (2¹), the BD limit for 60 kHz SCS reduces the base by a factor or 4 (2²), and the BD limit for 120 kHz SCS reduces the base by a factor of 8 (2³). The table depicted in FIG. 7A also shows the resulting reduction ratio (ratio of BD) compared to the BD limit for other types of UEs. As the power consumption may be proportional to the reduction ratio, FIG. 7A demonstrates that the BD limits set for certain SCSs provide a reduction in power consumption, which may provide a desirable hardware cost and power consumption for reduced capability UEs.

In certain cases, the maximum number of BDs per SCS in a slot may include a separate maximum number of BDs reserved for CSS sets and a separate maximum number of BDs reserved for USS sets, where the BD limits for USS sets are reduced for certain SCSs, and the BD limits for CSS sets remain constant. In other words, the maximum number of BDs for USS sets for a particular SCS provides a base maximum number of BDs, and the other SCSs may reduce the base maximum by a certain factor (such as 2^{x}) depending on the SCS. As an example, FIG. 7B shows a table of BD limits (i.e., maximums) in a slot for certain SCSs, in accordance with certain aspects of the present disclosure. In this example, while the BD limit for CSS sets remains constant at 12, the BD limit for 15 kHz provides the base BD limit, the BD limit for 30 kHz SCS reduces the base by half (2¹), the BD limit for 60 kHz SCS reduces the base by a factor or 4 (2²), and the BD limit for 120 kHz SCS reduces the base by a factor of 8 (2³). The table depicted in FIG. 7B also shows the resulting reduction ratio (ratio of BD) compared to the BD limit for other types of UEs. As the power consumption may be proportional to the reduction ratio, FIG. 7B demonstrates that the BD limits set for certain SCSs provide a reduction in power consumption, which may provide a desirable hardware cost and power consumption for reduced capability UEs. In certain aspects, the maximum number of BDs for USS sets may remain constant, while the maximum number of BDs for CSS sets may be reduced for certain SCSs.

While the examples depicted in FIGS. 7A and 7B provide certain BD limits for certain SCSs to facilitate understanding, aspects of the present disclosure may also be applied to a different value for the base maximum, a different SCS that provides the base maximum, and/or other SCSs (e.g., 120 kHz SCS).

In certain aspects, the PDCCH monitoring policies for a reduced capability UE may include various CCE policies. For example, similar policies as the BD policies described herein may also be applied to CCE limits per slot.

In certain aspects, the PDCCH monitoring policies for a reduced capability UE may include various aggregation level policies. The aggregation level (AL) determines the amount of time and frequency resources used for a PDCCH transmission. For example, the number of Control Channel Element (CCE) allocated to a PDCCH transmission is equal to the AL. For reduced capability UEs, due to the reduced number of receive (Rx) antennas, the UE may not be able to detect a PDCCH with relatively small AL as the received power of PDCCH decreases compared to other types of UEs with more Rx antennas. In certain aspects, the reduced capability UE may have a higher floor for the ALs. That is, the UE may not process PDCCH candidates in a search space set if AL for these PDCCH candidates is smaller than a threshold. The reduced capability UE may ignore the PDCCH candidates that are configured with a small AL (e.g., AL≤2). For example, if a CSS set is configured for both reduced capability UEs and other type of UEs, the PDCCH candidates with a small AL may only be for the other type of UEs.

In certain aspects, the PDCCH monitoring policies for a reduced capability UE may include various TCI state (i.e., QCL) policies. A Transmission Configuration Indicator (TCI) state indicates the QCL relationship between reference signals (e.g., between a DMRS and SSB or between a DMRS and CSI-RS) with respect to certain common channel properties (delay, Doppler and spatial). In 5G NR systems, a UE supports one more active TCI state for PDCCH than that for PDSCH. Therefore, a UE may have a minimum of two active TCI states for PDCCH. As the number of active TCI states configured for a UE is increased, the number of time, frequency, or spatial tracking loops to maintain also increases, which may exceed the capabilities of a reduced capability UE or be undesirable for a reduced capability UE.

For reduced capability UEs, the UE may support a number of active TCI states for PDCCH that is independent of the number of active TCI states for the PDSCH in the active BWP. For example, the UE may support the same number of or fewer active TCI states for the PDCCH than that for the PDSCH. Additionally or alternatively, a minimum number of supported active TCI states for the PDCCH in the active BWP may be set for reduced capability UEs. As an example, a reduced capability UE may be configured with a single active TCI state for the PDCCH in the active BWP in accordance with the minimum.

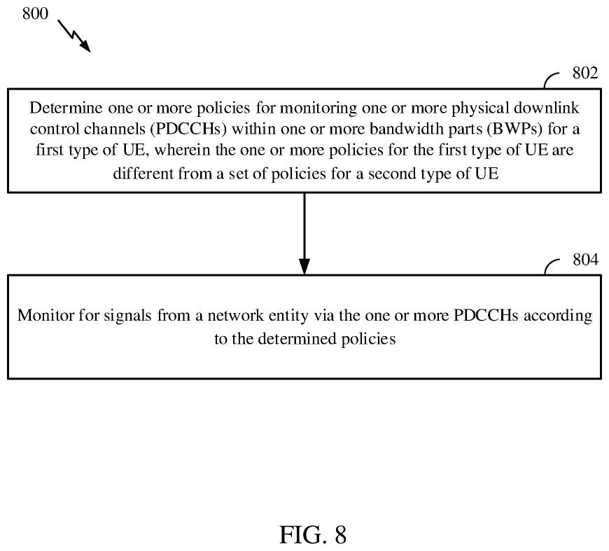

FIG. 8 is a flow diagram illustrating example operations 800 for wireless communication, in accordance with certain aspects of the present disclosure. The operations 800 may be performed, for example, by UE (e.g., the UE 120a in the wireless communication network 100). The operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin at 802, where the UE determines one or more policies for monitoring one or more PDCCHs within one or more BWPs for a first type of UE (e.g., a reduced capability UE or low complexity UE). In aspects, the one or more policies for the first type of UE are different from a set of policies for a second type of UE (e.g., a UE that supports eMBB or URLLC). At 804, the UE may monitor for signals from a network entity (e.g., the BS 110) via the one or more PDCCHs according to the determined policies.

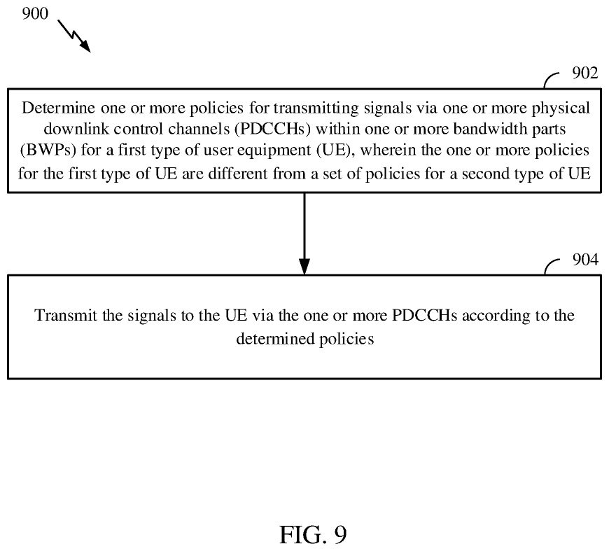

FIG. 9 is a flow diagram illustrating example operations 900 for wireless communication, in accordance with certain aspects of the present disclosure. The operations 900 may be performed, for example, by a network entity (e.g., the BS 110a in the wireless communication network 100). The operations 900 may be complimentary to the operations 800 performed by the UE. The operations 900 may be implemented as software components that are executed and run on one or more processors (e.g., controller/processor 240 of FIG. 2). Further, the transmission and reception of signals by the BS in operations 900 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 900 may begin at 902, where a network entity may determine one or more policies for transmitting signals via one or more PDCCHs within one or more BWPs for a first type of UE (e.g., a reduced capability UE or low complexity UE). In aspects, the one or more policies for the first type of UE are different from a set of policies for a second type of UE. At 904, the network entity may transmit the signals to the UE via the one or more PDCCHs according to the determined policies.

In certain cases, the UE may only monitor the CORESETs in an active BWP. That is, although a UE may be configured with CORESETs in multiple BWPs, the UE may only monitor control regions of the active BWP. For example, at 804, the UE may monitor for PDCCHs in the control regions (e.g., CORESETs) in the active BWP. At 804, the UE may monitor and/or receive multiple PDCCHs carrying various types of downlink control information (DCI).

In aspects, the one or more policies includes at least one of a blind decoding (BD) policy, a control channel element (CCE) policy, a control resource set (CORESET) policy, an aggregation level (AL) policy, or a transmission configuration indicator (TCI) state policy. In certain aspects, the BD policy includes a lower maximum number of BDs for a subcarrier spacing (SCS) in a time-domain resource unit than under the set of policies for the second type of UE. As used herein, a maximum number of BDs refers to the maximum number of BDs for the decoding of PDCCH candidates that a UE is capable of processing within a certain time-domain resource unit (e.g., a slot).

In certain cases, the BD policy may set BD limits as described herein with respect to FIG. 7A. For example, the BD policy may include a maximum number of BDs in a time-domain resource unit (e.g., a slot) per SCS, where the maximum number of BDs for a particular SCS (e.g., 15 kHz) provides a base maximum number of BDs, and the maximum number of BDs for another SCS is determined by reducing the base maximum number of BDs by a factor (e.g., 2^{x}) associated with the other SCS.

In certain cases, the BD policy may set BD limits as described herein with respect to FIG. 7B. For example, the maximum number of BDs per SCS may include a first maximum number of BDs for one or more common search spaces and a second maximum number of BDs for one or more UE-specific search spaces, where the second maximum number of BDs for a particular SCS (e.g., 15 kHz) provides a base maximum number of BDs, and the second maximum number of BDs for another SCS is determined by reducing the base maximum number of BDs by a factor associated with the other SCS. In certain aspects, the first maximum number for other SCSs may be reduced, while the second number remains constant.

In aspects, the CCE policy may include monitoring fewer CCEs for an SCS in a time-domain resource unit (e.g., a slot) than under the set of policies for the second type of UE. As used herein, a maximum number of CCEs refers to the maximum number of CCEs that a UE is capable of monitoring/processing within a certain time-domain resource unit (e.g., a slot). In certain cases, the CCE policy may set CCE limits under a similar policy as described herein with respect to FIG. 7A. For example, the CCE policy may include a maximum number of CCEs in a time-domain resource unit (e.g., a slot) per SCS, where the maximum number of CCEs for a particular SCS (e.g., 15 kHz) provides a base maximum number of CCEs, and the maximum number of CCEs for another SCS is determined by reducing the base maximum number of CCEs by a factor (e.g., 2^{x}) associated with the other SCS.

In certain cases, the CCE policy may set CCE limits under a similar policy as described herein with respect to FIG. 7B. For example, the maximum number of CCEs per SCS may include a first maximum number of CCEs for one or more common search spaces and a second maximum number of CCEs for one or more UE-specific search spaces, where the second maximum number of CCEs for a particular SCS (e.g., 15 kHz) provides a base maximum number of BDs, and the second maximum number of CCEs for another SCS is determined by reducing the base maximum number of CCEs by a factor (e.g., 2^{x}) associated with the other SCS.

In aspects, the CORESET policy includes monitoring fewer CORESETs or search space sets per BWP than under the set of policies for the second type of UE. In certain cases, the CORESET policy includes monitoring at most a single CORESET per BWP, a single CSS set per BWP, and a single USS set per BWP. In aspects, the CORESET policy may include not allowing a search space set occasion to fully overlap in a time-domain with another search space set occasion from a same search space set or from different search space sets within a same CORESET. That is, a reduced capability UE may not expect a search space set occasion to fully overlap in a time-domain with another search space set occasion from a same search space set or from different search space sets within a same CORESET. In certain aspects, the CORESET policy may include not allowing a search space set occasion within a first CORESET to fully or partially overlap in the time-domain with another search space set occasion within a second CORESET. In other words, a reduced capability UE may not expect a search space set occasion within a first CORESET to fully or partially overlap in time with another search space set occasion within a second CORESET. In certain cases, the CORESET policy may include allowing a search space set occasion for a first CORESET to fully overlap in time with another search space set occasion for a second CORESET if the first and second CORESETs have a same frequency domain resource allocation and time domain OFDM symbol duration. That is, a reduced capability UE may expect a search space set occasion for a first CORESET to fully overlap in time with another search space set occasion for a second CORESET only if the first and second CORESETs have a same frequency domain resource allocation and time domain OFDM symbol duration.

In aspects, the AL policy may set a higher floor for the ALs than under the set of policies for the second type of UE. For example, the AL policy may include a first minimum AL (e.g., AL=4) that is greater than a second minimum AL (e.g., AL=1) under the set of policies for the second type of UE.

In aspects, the TCI state policy may include a number of supported active TCI states configured for monitoring the PDCCH being independent of a number of supported active TCI states configured for a PDSCH associated with the PDCCH. That is, the number of supported active TCI states for the PDCCH may be less than, equal to, or greater than the number of supported active TCI states for the PDSCH. In aspects, the TCI state policy may include a minimum number of supported active TCI states for the PDCCH, such as at least a single active TCI state configured for monitoring the PDCCH.

In aspects, the UE may provide the network entity with an indication that the UE is a reduced capability UE with certain policies. For example, the UE may transmit, to the network entity, capability information indicating the one or more policies for the first type of UE. In certain cases, the UE may transmit, to the network entity, a signal indicating the one or more policies for the first type of UE. In aspects, the signal includes a random access channel (RACH) preamble sequence that indicates the one or more policies for the first type of UE.

In aspects, the network entity may configure the UE with CORESETs in one or more BWPs in accordance with the various policies for the first type of UE as described herein. For example, after determining the PDCCH monitoring policies for the UE, the network entity may transmit a CORESET configuration that indicates a number PDCCH candidates within the BD limits and/or CCE limits as described herein with respect FIG. 7A or FIG. 7B.

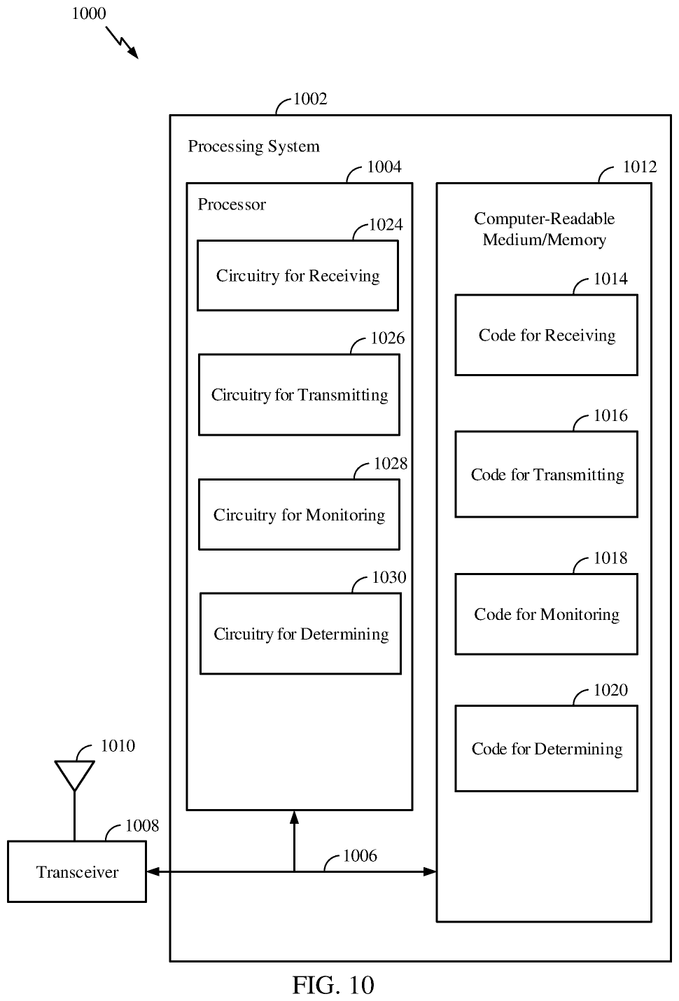

FIG. 10 illustrates a communications device 1000 (e.g., a UE or BS) that may include various components (e.g., corresponding to means-plus-function components) configured to perform operations for the techniques disclosed herein, such as the operations illustrated in FIGS. 8 and 9. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIGS. 8 and 9, or other operations for performing the various techniques discussed herein for low complexity PDCCH monitoring. In certain aspects, computer-readable medium/memory 1012 stores code for receiving 1014, code for transmitting 1016, code for monitoring 1018, and/or code for determining 1020. In certain aspects, the processor 1004 has circuitry configured to implement the code stored in the computer-readable medium/memory 1012. The processor 1004 includes circuitry for receiving 1024, circuitry for transmitting 1026, circuitry for monitoring 1028, and/or circuitry for determining 1030.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 8 and/or FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communication by a user equipment (UE), comprising:
determining one or more first policies for monitoring one or more physical downlink control channels (PDCCHs) within one or more bandwidth parts (BWPs) for a first type of UE, wherein at least one of the one or more first policies for the first type of UE is different from one or more second policies for a second type of UE; and
monitoring for signals from a network entity via the one or more PDCCHs according to the determined one or more first policies.

2. The method of claim 1, wherein the one or more first policies include at least one of:
a blind decoding (BD) policy,
a control channel element (CCE) policy,
a control resource set (CORESET) policy,
an aggregation level (AL) policy, or
a transmission configuration indicator (TCI) state policy.

3. The method of claim 2, wherein:
the BD policy includes a lower maximum of BDs for a subcarrier spacing (SCS) than under the one or more second policies for the second type of UE;
the CCE policy includes monitoring fewer CCEs for an SCS than under the one or more second policies for the second type of UE;
the CORESET policy includes monitoring fewer CORESETs or search space sets per BWP than under the one or more second policies for the second type of UE; and
the AL policy includes a first minimum AL that is greater than a second minimum AL under the one or more second policies for the second type of UE.

4. The method of claim 3, wherein:
the BD policy includes a maximum number of BDs in a time-domain resource unit per SCS;
the maximum number of BDs for a particular SCS provides a base maximum number of BDs; and
the maximum number of BDs for another SCS is determined by reducing the base maximum number of BDs by a factor associated with the other SCS.

5. The method of claim 3, wherein:
the BD policy includes a maximum number of BDs in a time-domain resource unit per SCS;
the maximum number of BDs per SCS includes a first maximum number of BDs for one or more common search spaces and a second maximum number of BDs for one or more UE-specific search spaces;
the second maximum number of BDs for a particular SCS provides a base maximum number of BDs; and
the second maximum number of BDs for another SCS is determined by reducing the base maximum number of BDs by a factor associated with the other SCS.

6. (canceled)

7. The method of claim 3, wherein:
the CCE policy includes a maximum number of CCEs in a time-domain resource unit per SCS;
the maximum number of CCEs for a particular SCS provides a base maximum number of CCEs; and
the maximum number of CCEs for another SCS is determined by reducing the base maximum number of CCEs by a factor associated with the other SCS.

8. The method of claim 3, wherein:
the CCE policy includes a maximum number of CCEs in a time-domain resource unit per SCS;
the maximum number of CCEs per SCS includes a first maximum number of CCEs for one or more common search spaces and a second maximum number of CCEs for one or more UE-specific search spaces;
the second maximum number of CCEs for a particular SCS provides a base maximum number of BDs; and
the second maximum number of CCEs for another SCS is determined by reducing the base maximum number of CCEs by a factor associated with the other SCS.

9. (canceled)

10. The method of claim 3, wherein the CORESET policy includes monitoring at most:
a single CORESET per BWP;
a single common search space set per BWP; and
a single UE-specific search space set per BWP.

11. The method of claim 2, wherein:
the CORESET policy includes not allowing a search space set occasion to fully overlap in time with another search space set occasion from a same search space set or from different search space sets within a same CORESET; or
the CORESET policy includes not allowing a search space set occasion within a first CORESET to fully or partially overlap in time with another search space set occasion within a second CORESET; or
the CORESET policy includes allowing a search space set occasion for a first CORESET to fully overlap in time with the other search space set occasion for the second CORESET if the first CORESET and the second CORESET have a same frequency domain resource allocation and time domain symbol duration.

12. (canceled)

13. (canceled)

14. (canceled)

15. The method of claim 2, wherein the TCI state policy includes a number of active TCI states configured for monitoring the PDCCH being independent of a number of active TCI states configured for a physical downlink shared channel (PDSCH) associated with the PDCCH.

16. The method of claim 2, wherein the TCI state policy includes allowing for a single active TCI state configured for monitoring the PDCCH.

17. (canceled)

18. The method of claim 2, further comprising transmitting, to the network entity, a signal indicating the one or more first policies for the first type of UE.

19. (canceled)

20. A method of wireless communication by a network entity, comprising:
determining one or more first policies for transmitting signals via one or more physical downlink control channels (PDCCHs) within one or more bandwidth parts (BWPs) for a first type of user equipment (UE), wherein at least one of the one or more first policies for the first type of UE is different from one or more second policies for a second type of UE; and
transmitting the signals to the UE via the one or more PDCCHs according to the determined one or more first policies.

21. The method of claim 20, wherein the one or more first policies include at least one of:
a blind decoding (BD) policy,
a control channel element (CCE) policy,
a control resource set (CORESET) policy,
an aggregation level (AL) policy, or
a transmission configuration indicator (TCI) state policy.

22. The method of claim 21, wherein:
the BD policy includes a lower maximum of BDs for a subcarrier spacing (SCS) than under the one or more second policies for the second type of UE;
the CCE policy includes monitoring fewer CCEs for an SCS than under the one or more second policies for the second type of UE;
the CORESET policy includes monitoring fewer CORESETs or search space sets per BWP than under the one or more second policies for the second type of UE; and
the AL policy includes a first minimum AL that is greater than a second minimum AL under the one or more second policies for the second type of UE.

23. The method of claim 22, wherein:
the BD policy includes a maximum number of BDs in a time-domain resource unit per SCS;
the maximum number of BDs for a particular SCS provides a base maximum number of BDs; and
the maximum number of BDs for another SCS is determined by reducing the base maximum number of BDs by a factor associated with the other SCS.

24. The method of claim 22, wherein:
the BD policy includes a maximum number of BDs in a time-domain resource unit per SCS;
the maximum number of BDs per SCS includes a first maximum number of BDs for one or more common search spaces and a second maximum number of BDs for one or more UE-specific search spaces;
the second maximum number of BDs for a particular SCS provides a base maximum number of BDs; and
the second maximum number of BDs for another SCS is determined by reducing the base maximum number of BDs by a factor associated with the other SCS.

25. (canceled)

26. The method of claim 22, wherein:
the CCE policy includes a maximum number of CCEs in a time-domain resource unit per SCS;
the maximum number of CCEs for a particular SCS provides a base maximum number of CCEs; and
the maximum number of CCEs for another SCS is determined by reducing the base maximum number of CCEs by a factor associated with the other SCS.

27. The method of claim 22, wherein:
the CCE policy includes a maximum number of CCEs in a time-domain resource unit per SCS;
the maximum number of CCEs per SCS includes a first maximum number of CCEs for one or more common search spaces and a second maximum number of CCEs for one or more UE-specific search spaces;
the second maximum number of CCEs for a particular SCS provides a base maximum number of BDs; and
the second maximum number of CCEs for another SCS is determined by reducing the base maximum number of CCEs by a factor associated with the other SCS.

28. (canceled)

29. The method of claim 22, wherein the CORESET policy includes configuring at most:
a single CORESET per BWP;
a single common search space set per BWP; and
a single UE-specific search space set per BWP.

30. The method of claim 21, wherein:
the CORESET policy includes not allowing a search space set occasion to fully overlap in time with another search space set occasion from a same search space set or from different search space sets within a same CORESET; or
the CORESET policy includes not allowing a search space set occasion within a first CORESET to fully or partially overlap in time with another search space set occasion within a second CORESET; or
the CORESET policy includes allowing a search space set occasion for a first CORESET to fully overlap in time with the other search space set occasion for the second CORESET if the first CORESET and the second CORESET have a same frequency domain resource allocation and time domain symbol duration.

31. (canceled)

32. (canceled)

33. (canceled)

34. The method of claim 21, wherein the TCI state policy includes a number of active TCI states configured for monitoring the PDCCH being independent of a number of active TCI states configured for a physical downlink shared channel (PDSCH) associated with the PDCCH.

35. The method of claim 21, wherein the TCI state policy includes allowing for a single active TCI state configured for monitoring the PDCCH.

36. (canceled)

37. The method of claim 21, further comprising receiving, from the UE, a signal indicating the one or more first policies for the first type of UE.

38. (canceled)

39. An apparatus for wireless communication, comprising:
at least one processor configured to determine one or more first policies for monitoring one or more physical downlink control channels (PDCCHs) within one or more bandwidth parts (BWPs) for a first type of user equipment (UE), wherein at least one of the one or more first policies for the first type of UE is different from one or more second policies for a second type of UE;
a transceiver configured to monitor for signals from a network entity via the one or more PDCCHs according to the determined one or more first policies; and
memory coupled to the at least one processor.

40. An apparatus for wireless communication, comprising:
at least one processor configured to determine one or more first policies for transmitting signals via one or more physical downlink control channels (PDCCHs) within one or more bandwidth parts (BWPs) for a first type of user equipment (UE), wherein at least one of the one or more first policies for the first type of UE is different from one or more second policies for a second type of UE;
a transceiver configured to transmit the signals to the UE via the one or more PDCCHs according to the determined one or more first policies; and
memory coupled to the at least one processor.

41. (canceled)

42. (canceled)

43. (canceled)

44. (canceled)

45. The apparatus of claim 39, wherein the one or more first policies include at least one of:
a blind decoding (BD) policy,
a control channel element (CCE) policy,
a control resource set (CORESET) policy,
an aggregation level (AL) policy, or
a transmission configuration indicator (TCI) state policy.

46. The apparatus of claim 45, wherein:
the BD policy includes a lower maximum of BDs for a subcarrier spacing (SCS) than under the one or more second policies for the second type of UE;
the CCE policy includes monitoring fewer CCEs for an SCS than under the one or more second policies for the second type of UE;
the CORESET policy includes monitoring fewer CORESETs or search space sets per BWP than under the one or more second policies for the second type of UE; and
the AL policy includes a first minimum AL that is greater than a second minimum AL under the one or more second policies for the second type of UE.

47. The apparatus of claim 40, wherein the one or more first policies include at least one of:
a blind decoding (BD) policy,
a control channel element (CCE) policy,
a control resource set (CORESET) policy,
an aggregation level (AL) policy, or
a transmission configuration indicator (TCI) state policy.

48. The apparatus of claim 47, wherein:
the BD policy includes a lower maximum of BDs for a subcarrier spacing (SCS) than under the one or more second policies for the second type of UE;
the CCE policy includes monitoring fewer CCEs for an SCS than under the one or more second policies for the second type of UE;
the CORESET policy includes monitoring fewer CORESETs or search space sets per BWP than under the one or more second policies for the second type of UE; and
the AL policy includes a first minimum AL that is greater than a second minimum AL under the one or more second policies for the second type of UE.
